(19) United States
(12) Patent Application Publication
(10) Pub. No.: US 2012/0061946 A1
(43) Pub. Date: Mar. 15, 2012

(54) Airbag Having Functional Elements Integrated in the Weave

(75) Inventors: Christian Burczyk, Stuttgart (DE); Andreas Hirth, Dielheim (DE); Lutz Quarg, Boeblingen (DE); Friedrich Reiter, Sindelfingen (DE); Clark Ruedebusch, Holzgerlingen (DE)

(73) Assignee: Daimier AG, Stuttgart (DE)

(21) Appl. No.: 13/321,032

(22) PCT Filed: May 4, 2010
(86) PCT No.: PCT/EP2010/002707

§ 371 Date: Nov. 17, 2011

(30) Foreign Application Priority Data
May 19, 2009 (DE) 10 2009 021 854.8

(51) Int. Cl. B60R 21/16; B23P 11/00; B60R 21/26

(52) U.S. Cl. 280/728.1; 280/742; 29/428

(57) ABSTRACT

An air bag is provided with a air cushion formed of one woven fabric. At least one functional element, which provides the airbag with an additional function, is woven into the air cushion in one piece. The functional element can be a tube system of a support structure airbag and/or a valve for unfolding of a support structure airbag.

### BACKGROUND AND SUMMARY OF THE INVENTION

The present invention relates to an airbag for protection of occupants in a motor vehicle with an airbag manufactured of a woven fabric.

German Patent Publication DE 10 2006 038 124 A1 discloses a generic airbag manufactured of a woven fabric. The restraint system for a motor vehicle described in this document is formed by one or several support structures and a restraint volume, whereby the longitudinal extension of a support structure in the active state substantially exceeds the dimensions of the transverse extension and the support structure mainly unfolds in the direction of its longitudinal extension. The size of the restraint system adapts to the respective load, in that when an obstacle is encountered, the support structure does not achieve the stability during unfolding that it would have if it unfolded completely.

In addition, German Patent Publication DE 10 2006 038 125 A1 describes a restraint system for a motor vehicle, which unfolds from a storage position into a restraint position, whereby the unfolding occurs by means of at least one support structure that is inflatable by means of a gas pressure source. In the restraint position, the restraint system is available to the occupant in the occupant's direction of displacement with a restraint volume for restraint of the occupant, whereby the restraint volume is surrounded by at least one flexible restraint structure. In order to improve the restraint system in such a way that the size of the restraint system adapts to the load in the particular case, the flexible restraint structure is deployed through inflation of the support structure so that it surrounds the restraint volume.

German Patent Publication DE 44 42 592 A1 disclose an impact protection device includes an air bag manufactured of a woven fabric consisting of an upper part, a lower part and several capture tapes arranged inside the air bag. The capture tapes are formed from extensions of woven fabric sections of reinforcing parts attached to the inner side of the upper part and the lower part directed towards the inner chamber.

The extending, overlapping woven fabric sections are connected in approximately a central area between the upper part and lower part by means of a joining location, which in particular is sewn. In this arrangement, each capture tape is continuously formed in at least two layers between the upper part and the lower part, and the layers are connected with each other at least at the joining location.

In addition, Publication EP 0 714 813 B1 describes an inflatable restraint cushion. The restraint cushion is formed of a one-piece section of material and serves for use in connection with an inflation device for the protection of a vehicle occupant in case of a collision. Boundary edge sections of the material cut-out can be brought together, lying above one another, by means of two completely or mostly continuous seams. Therefore, an OPW (One Piece Woven) method is known for the manufacture of air cushions of airbags. It is also known to sew together several sections of an air sac. However, in general, the cost and time needed for manufacture of airbags and in particular for manufacture of support structure airbags is relatively great.

Therefore, exemplary embodiments of the present invention are directed to reducing the cost and time needed for manufacture of an airbag.

According to exemplary embodiments of the present invention, an airbag for protection of occupants in a motor vehicle is provided with an air cushion, which is manufactured of a woven fabric, whereby in the air cushion at least one functional element, which provides the air cushion with an additional function, is woven in one piece.

Furthermore, a process for manufacturing an airbag for protection of occupants in a motor vehicle is provided, including the step of weaving of an air cushion, whereby at least one functional element is woven into the air cushion in integrated form which provides the air cushion with an additional function.

Therefore, in advantageous fashion, an air cushion with its typical function of enclosure of a gas is provided with an additional function, which is provided by a functional element woven into the woven fabric. During the manufacturing step of weaving, therefore, not only the air cushion itself is manufactured, but the air cushion is additionally provided with a function which goes beyond the basic function of the air cushion. This means that the additional functional element does not need to be integrated into the air cushion with a manufacturing step specifically designed for the purpose. Therefore, the manufacturing process as a whole can be simplified.

In one embodiment, the airbag is formed as a support structure airbag. In connection with the present invention, a support structure and a flexible planar formation that can be deployed by the support structure is designated as a support structure airbag, as is described in DE 10 2006 038 124 A1 and DE 10 2006 038 125 A1. During an unfolding of the support structure, a restraint volume is limited by the flexible planar formation and can basically contain ambient air, whereby filling or emptying of the restraint volume with ambient air can be influenced by means of a valve device.

In this embodiment it is particularly advantageous if the functional element that is woven into the air cushion is a tube element of the support structure, which is inflated when the airbag unfolds. The functional element preferably represents the entire tube system of a support structure that is inflated during unfolding of the airbag. The flexible planar formation, which can also be designated as planar support elements, can be formed by planar connecting sections located between individual tubes of the tube system with which it forms one piece. It is therefore possible that the air cushion of a support structure airbag is manufactured together with the support structure in one single work step, namely the weaving of the air cushion or a part of it. Therefore a support structure does not have to be joined onto the planar support elements afterwards, nor is it necessary to create tube elements of the support structure by means of sewing and adhesive bonding.

According to a further embodiment, the woven-in functional part or a further woven-in functional part can be a valve. This means that the air cushion can, without a great expenditure of time or money, be provided with an element with which the gas volume in the air cushion can be regulated.

In particular, the valve can be designed in such a way that it opens during the unfolding of the airbag and closes when the unfolded air cushion is placed under load.

This means that support structure airbags in which the ambient air is sucked into the interior chamber of the airbag through the valves can be implemented in an advantageous fashion. Upon loading, the valves close, so that the air cushion can provide the restraining force.

The valve preferably possesses two layers of woven fabric that can move relative to one another. In this arrangement, one layer is considerably more gas-permeable than the other and only forms the support for the other layer when the valve is closed. A valve can be created in a multi-layer air cushion in this way without difficulty.

According to a further preferable embodiment, the entire air cushion is formed of a one-piece woven fabric section. This dispenses with the need for numerous sewn, bonded or welded joins.

In addition, sections of the fabric cut-out can be connected with each other at their edges. This means that single sections that are separate from one another do not have to be correctly orientated to one another before the sewing, welding or adhesive bonding. It is rather the case that the sections are correctly orientated towards one another from the beginning.

### BRIEF DESCRIPTION OF THE DRAWING FIGURES

The present invention will now be described based on the attached drawings. The drawings show the following:

FIG. 1 shows a fabric section for a support structure airbag according to the invention, spread out flat;

FIG. 2 shows the woven fabric section of FIG. 1 in a three-dimensionally folded state;

FIG. 3 shows a valve woven into a planar formation in the flow-through state and

FIG. 4 shows the valve of FIG. 3 in the blocked state.

The embodiments described in more detail below represent preferred embodiments of the present invention.

### DETAILED DESCRIPTION

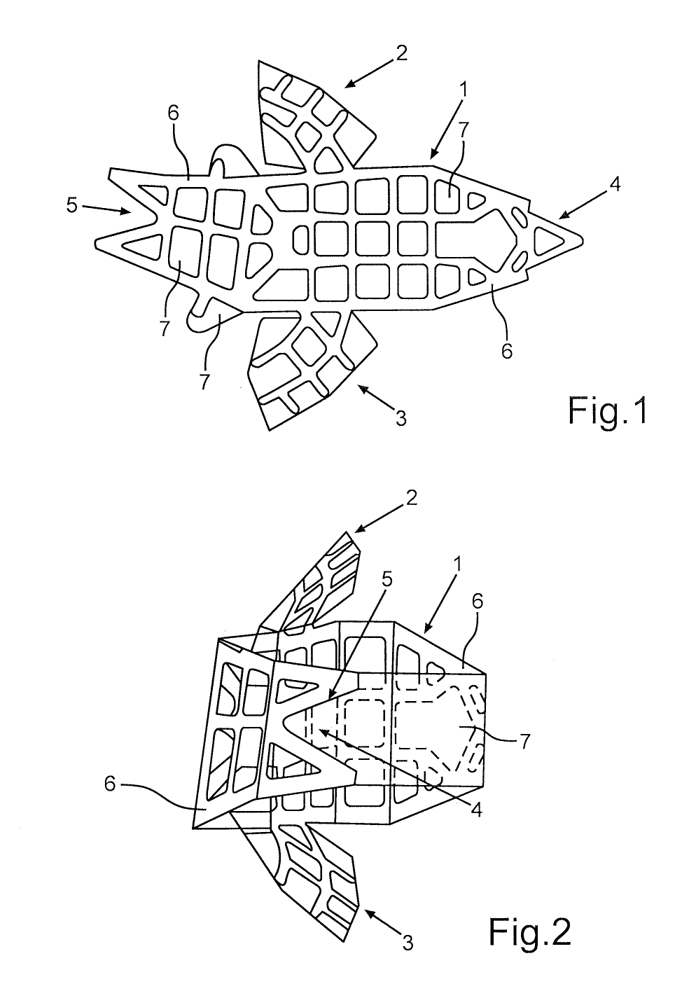

In FIG. 1, a woven fabric section for the air cushion of a support structure airbag is shown as an example. The woven fabric section is here laid out flat and shown from above. It silhouette approximates to that of a flying bird. Two wing sections 2 and 3 are woven onto an end section 1. On one side of the end section 1 there is a point 4 corresponding to the beak of the bird silhouette. On the opposite side of the end section 1, a notch 5 is provided in the woven fabric section, corresponding to the tail of the bird silhouette.

A network-like tube system 6 is integrated into the entire woven fabric section. This tube system 6 is formed by two layers of the woven fabric. In the present example, these two layers are only connected to one another at special connection sections 7. These connection sections 7 correspond to the mesh of the network-like tube system 6. Tube system 6 is a closed system and basically only possesses one or a few inlet openings, in order that gas can flow into tube system 6. Tube system 6 possesses numerous individual tube elements that are connected to one another and form the network-like support structure for the airbag.

In the state shown in FIG. 1, tube system 6 is collapsed. This means that the two layers of the woven fabric section lie on top of one another, also in the area of the tube system. Only when tube system 6 is filled with gas do the individual tube elements unfold into cylindrical shapes, which possess a certain strength and therefore can become part of the support structure.

Manufacture of the fabric section can practically be carried out in one work step. Namely, the two woven layers are only woven and woven together at connection sections 7. In the area of tube system 6, the two layers are not woven together. Any cutting out from an entire piece of woven fabric is not taken into consideration here.

Following the weaving, the woven fabric section is folded three-dimensionally in accordance with FIG. 2 and joined together at the intended edge sections.

In the example of FIG. 2 it can be seen how point 4 is fitted into notch 5 of the fabric section. The joining of the edges is performed by means of sewing, adhesive bonding and/or welding. The ring-shaped formation of FIG. 2 is joined with wing sections 2 and 3 at its open sides. Here it is advantageous that wing sections 2 and 3 are already woven onto the woven fabric section in integral form. This means that, during the joining process, it is not necessary to establish the correct orientation of the wing sections before the edges are joined. However, it can be seen immediately that following the joining of the wing sections 2 and 3 to the provided edges of end section 1, a sac-shaped formation, namely the air cushion, is created.

In order to unfold the air cushion, air is pressed into tube system 6, which was previously flat. This means that tube system 6 now forms a support structure, whereby connecting sections 7 form planar support elements between the support structure elements. For the unfolding of the airbag, it is necessary, however, that ambient air can penetrate into it. This is only possible through corresponding openings or valves in the air cushion. As the air cushion has to provide a certain defined restraint force in its unfolded state, valves are generally built into the air cushion.

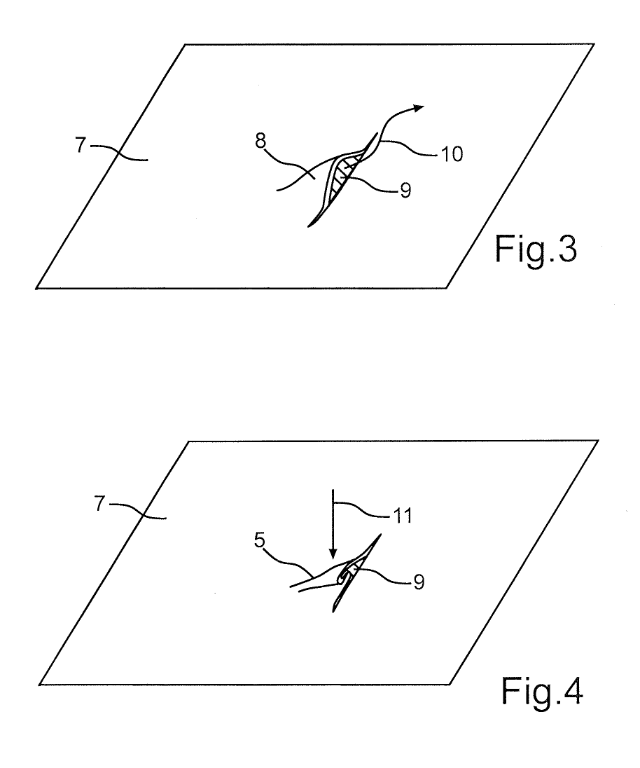

According to one embodiment of the invention, the valves can be woven immediately into the air cushion. Such a valve in shown in FIGS. 3 and 4. The valve itself consists completely of the same woven fabric as the air cushion itself. It is implemented through the fact that two layers of woven fabric, or two partial layers can be moved in relation to one another. Within this arrangement, the valve can be miniaturized to the extent the one fabric layer is implemented by means of a single thread.

In the example shown in FIG. 3, the valve is formed in a planar connecting section 7 (compare FIGS. 1 and 2). It can also be formed on any section of an air cushion woven in the normal way.

In the example shown in FIG. 3, the woven fabric of planar connecting section 7 consists of two layers; an upper layer and a lower layer. A movable valve section 8 is formed by the upper layer. The movable valve section 8 here is in the form of a half dome and is formed by an expansion of the upper layer. An immovable valve section 9 is formed by the lower layer of the woven fabric. In the present example, the immovable valve section 9 only consists of weft threads or warp threads of the lower layer. This means that immovable valve section 9 is gas-permeable and ambient air can flow into the interior of the air cushion corresponding to flow arrow 10.

If the air cushion is completely unfolded and an occupant presses on the air cushion from outside, a pressure 11 comes to bear upon valve 8, 9 as shown in FIG. 4. The half dome-shaped valve section 8 then collapses upon itself and closes the opening through which air flowed in during unfolding. This means that air can hardly flow to the outside any more, or can only flow to a small defined extent.

Valves that are woven into the planar element of an air cushion can also in principle be constructed in a different way. For example, both layers can also be woven into a tube-shaped formation, which renders inflow of air possible and which folds over during reverse flow and closes the opening.

A capture tape can also in principle be woven in one piece immediately onto a fabric section or in general. Here, for example, a layer of the woven fabric can form the closed air cushion and a partial section of the other layer can be realized as a capture tape, which is only connected to the first layer at one end.

As the above embodiments show, a support structure airbag can therefore be manufactured using only a few manufacturing steps. Naturally one or several additional parts can be connected with the basically one-piece air cushion, without departing from the scope of the present invention. An example of such an additional part is a flame protection layer which protects the air cushion against hot gases of a gas generator. In a further example, valves can also be attached as additional parts. In particular, manufacture of the tubes and the valves can be implemented by means of the OPW method (if appropriate in one common manufacturing step). Finally the fabric section only remains to be sewn, welded or adhesively bonded. Here, therefore, the OPW method is combined with the sewing of an air cushion. This created a three-dimensional air cushion from an air cushion that in its restraint position is in principle two-dimensional—apart from its thickness in relation to its surface. This airbag can therefore also contain ambient air. Considered from the functional point of view, at least two air cushions can be created, which are woven in one piece. The air cushions can differ with regard to their characteristics, such as for example the internal gas pressure. In one embodiment, one airbag encloses the other at least partially.

From a basically one-piece, flat formation with functional elements, by these means an additional volume can be created, which is at least in part enclosed by the planar formation with function elements, by means of which at least one additional function is made possible. An example of such an additional function is a possible restraint effect by means of ambient air for occupant protection in a motor vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-14. (canceled)

15. An airbag for protection of an occupant in a motor vehicle, comprising:
an air cushion of a woven fabric; and
at least one functional element integrated in woven-in form in the air cushion, the at least one function element configured to provide the air cushion with an additional function.

16. The airbag according to claim 15, wherein the airbag is a support structure airbag.

17. The airbag according to claim 16, wherein the at least one functional element is a tube element of the support structure which is inflated during unfolding of the airbag.

18. The airbag according to claim 16, wherein the at least one functional element is an entire tube system of the support structure, which is inflated during unfolding of the airbag.

19. The airbag according to claim 15, wherein the at least one function element or a further functional element woven into the air cushion as one piece is a valve.

20. The airbag according to claim 19, wherein the valve is configured to open during unfolding of the airbag and close when the unfolded airbag is under load.

21. The airbag according to claim 20, wherein the valve has two layers of fabric that are movable in relation to one another.

22. The airbag according to claim 15, wherein the at least one functional element or a further functional element woven in one piece is a capture tape.

23. The airbag according to claim 15, wherein the entire air cushion is formed of one one-piece fabric section.

24. The airbag according to claim 23, wherein sections of the fabric section are joined together at their edges.

25. A process for manufacture of a support-structure airbag for occupant protection in a motor vehicle, comprising the step of:
weaving of a air cushion, wherein at least one functional element is woven in one piece in the air cushion, and the at least one functional element is configured to provide the air cushion with an additional function.

26. The process according to claim 25, wherein a tube element, a valve or a capture tape is woven into the air cushion as the at least one functional element.

27. The process according to claim 25, wherein the entire air cushion is formed of a one-piece fabric cut-out.

28. The process according to claim 27, wherein sections of the fabric section are joined to one another at their edges.
